(19) United States
(12) Patent Application Publication
(10) Pub. No.: US 2024/0368807 A1
(43) Pub. Date: Nov. 7, 2024

(54) DEVICES AND METHODS FOR LIQUID PROCESSING OF FIBROUS SOLIDS

(71) Applicants: Jeffrey L. HONIG, Newport News, VA (US); Samuele BATTAH, Newport News, VA (US); Canon Virginia, Inc., Newport News, VA (US)

(72) Inventors: Jeffrey L Honig, Yorktown, VA (US); Samuele Battah, Yorktown, VA (US)

(21) Appl. No.: 18/573,176

(22) PCT Filed: Jun. 24, 2022
(86) PCT No.: PCT/US2022/034938

§ 371 Date: Dec. 21, 2023

(51) Int. Cl. D01C 3/02

(52) U.S. Cl. CPC D01C 3/02

(57) ABSTRACT

The present disclosure relates to screened cages to contain fibrous and other bulky materials during liquid-solid processing that can allow optimized flow of the materials within the screened cages for mass transfer, heat transfer and prevent packing of the material that would obstruct liquid flow. In addition, the screened cages enable safer handling in high temperature or corrosive environments.

### PRIORITY AND INCORPORATION BY REFERENCE

The present application claims priority to U.S. Provisional Patent Application Ser. No. 63/215,020 filed Jun. 25, 2021, the disclosure of which is incorporated herein by reference in its entirety.

### FIELD OF THE DISCLOSURE

The present disclosure relates to devices and methods for use in liquid processing of fibrous solids.

### BACKGROUND

The handling of fibrous solids can be difficult and often can be unsafe. When trying to process fibrous solids in liquid for liquid extraction, boiling, etc. the fibrous materials tend to aggregate or bunch up and can wrap around a processing tank's internal devices and features, becoming difficult to remove from the processing tank. This aggregation or packing of the fibrous solids also creates uneven temperatures within the fibrous solid mass and prevents uniform liquid flow within the fibrous solid mass which can be crucial for liquid extraction and other reactions.

### SUMMARY OF THE DISCLOSURE

The above-described issue can be addressed by containing the fibrous solids within screened cages inside of a processing tank, such that the fibrous solids will not aggregate and/or wrap around a processing tank's internal devices and features. This enables easier and safer loading and unloading of the fibrous solids into the processing tank. In addition, the screened cages enable the fluid to freely interact with the fibrous solids. The locations of the screened cages can be optimized within the processing tank for best movement of the fibrous solids within the screened cages, allowing the fluid to uniformly interact with the fibrous solids. This allows for a consistent and repeatable method for heat transfer, liquid extraction, etc.

An aspect of the present disclosure includes devices and methods for holding fibrous solids in screened cages for liquid processing of the fibrous solids inside a tank. The screened cages can be customized based on the material they are to contain, and the processing that material will undergo. The screened cages are designed with the strength required to hold the weight of the wet fibrous solids and to withstand the fluidic forces resulting from processing in the liquid tank. In addition, the screens are designed with screen opening sizes that prevent the fibrous solids from either partially or completely escaping the screened cages while still enabling fluid to enter and leave the cage for proper processing.

Another aspect of the present disclosure includes optimizing the location of screened cages within the liquid tank to create a flow pattern within the screened cages to enable a mass of fibrous solids to rotate within the screened cage and not pack to one side or corner of the screened cage. Once the mass of fibrous solids is rotating in the cage with flow of the fluid into and out of the cage per the above-described aspect, consistent and repeatable processing operations can be performed. For example, the amount of heat transfer to maintain a uniform temperature within the fibrous mass, the ability for liquid solvent to extract material from the fibrous solids, reaction times between the liquid and fibrous solid, etc. can be standardized.

According to yet another aspects of the present disclosure, common scale up methods for predicting heat transfer, mass transfer, blending time, etc. can be utilized as the fibrous solids processed in the disclosed screened cages do not increase in mass and thickness as the scale increases. As long as the screened cages can be handled in a larger scale and the rotation of the fibrous solid mass can be achieved in the screened cages, processing conditions and quality of the output product can be more accurately predicted.

Thus, in more detail, an aspect of the present disclosure provides a method of processing fibrous solids, including silk cocoons, cellulose or animal fibers, in liquid comprising the steps (in any order) of adding liquid to a processing tank, optionally adding one or more reagents to the processing tank, providing at least one screened cage containing fibrous solids, adding the at least one screened cage to the processing tank, agitating the liquid in the processing tank such that the liquid uniformly flows through the at least one screened cage; wherein the fibrous solids rotate freely within the at least one screened cage. In a further aspect, the liquid freely flows through the at least one screened cage. In another aspect, the fibrous solids are dissolved to release one or more components of the fibrous solids. In some aspects, the one or more reagents can be a solvent or a salt, including sodium carbonate. In some aspects, the liquid added to the tank can act as a solvent.

In another aspect, the one or more components are retained within the screened cage. In the case of silk cocoons as the fibrous material, fibroin can be released from the fibrous material and retained in the screened cage. In one aspect, the one or more retained components are subjected to an agitation flow path that prevents packing of the one or more retained components within the screened cage. To facilitate such agitation flow path, the at least one screened cage comprises mesh having an opening sufficient to allow for fluid agitation flow within the at least one screened cage, wherein the opening is sized to contain the retained components, and prevent the fibrous materials from clogging or wrapping around the mesh.

In a further aspect, manual or automatic means are used to add the at least one screened cage to the processing tank such that the screened cage is placed into a desired position in a repeatable manner. Once in position, the at least one screened cage is secured such that rotation and/or deflection of the at least one screened cage from the desired position is prevented.

Additionally, further processing steps can also be performed, including, but not limited to any combination of removing the one or more screened cages from the tank, inserting the one or more screened cages into an oven; and drying the retained retained components and/or fibrous materials. In one aspect, the step of removing the one or more screened cages from the tank results in the draining of liquid from the one or more screened cages. Further, in another aspect the at least one screened cage is subjected to centrifugal force to remove one or more reagents from the retained components. In another aspect, additional processing can be performed on the retained material with the at least one screened cage such as dissolving or a chemical reaction.

Another aspect of the present disclosure includes a device for processing fibrous solids in liquid comprising at least one screened cage having a lid. Fibrous solids can include cocoons, cellulose, or animal fibers. In one aspect, the lid is removably attached, including possibly by one or more latches.

In a further aspect, the screened cage can comprise an external support structure and one or more mesh walls located interior to the external support structure. Such mesh walls allow for a fluid flow pattern within the screened cage. Thus, fluid is able to flow into an out of the screened cage, while the fibrous solids and desired components are contained therein. In a further aspect, the screened cage is configured to function as a sieve to remove liquid from a material placed inside the screened cage.

These and other embodiments, features, and advantages of the present disclosure will become apparent upon reading the following detailed description of exemplary embodiments of the present disclosure, when taken in conjunction with the appended drawings, and provided claims. It is particularly noted that any of the components, method steps or the like described above can be utilized in the practice of the present invention in any combination or order. Thus, for instance, a description of providing liquid in a processing tank before adding fibrous solids in screened cages does not prevent the practice of the present disclosure whereby the fibrous solids in screened cages are added before the liquid, etc.

### BRIEF DESCRIPTION OF THE DRAWINGS

The accompanying drawings, which are incorporated herein and form part of the specification, illustrate various embodiments, objects, features, and advantages of the present disclosure.

FIG. 1 is an illustration of an exemplary tank used for liquid extraction containing screened cages according to the present application.

FIG. 2A is an illustration of an exemplary screened cage and lid according to the present application. FIG. 2B is a side view illustration of an exemplary screened cage according to the present application. FIG. 2C is a top view illustration of an exemplary screened cage having no lid attached according to the present application.

FIG. 3 is an illustration of an exemplary flow pattern of a liquid within a liquid extraction tank.

FIG. 4 is an illustration of fibrous material in a exemplary screened cage and an exemplary flow pattern of a liquid within the screened cage according to the present application.

FIG. 5 is an illustration of an exemplary tank depicting dimensions that can be used for locating screened cages to optimize heat and mass transfer.

FIG. 6 is a top view illustration of an exemplary tank depicting screened cages therein.

FIG. 7 is a flow chart describing a method according to the present application.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative exemplary embodiments. It is intended that changes and modifications can be made to the described exemplary embodiments without departing from the true scope and spirit of the subject disclosure as defined by the appended claims.

### DETAILED DESCRIPTION OF EXEMPLARY EMBODIMENT

The present disclosure has several embodiments and relies on patents, patent applications and other references for details known to those of the art. Therefore, when a patent, patent application, or other reference is cited or repeated herein, it should be understood that it is incorporated by reference in its entirety for all purposes as well as for the proposition that is recited.

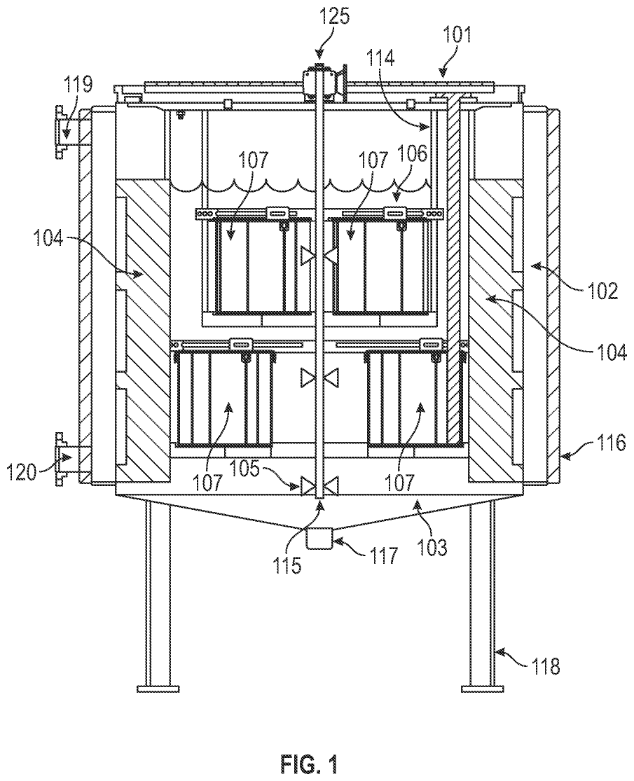

FIG. 1 provides an illustration of a tank 101 used for the liquid processing of fibrous solids. In one non-limiting, exemplary embodiment, the fibrous solids can be silk cocoons, for example, those of the Bombyx mori silk moth or the Bombyx mandarina wild silk moth. Other examples of fibrous solids include, without limitation, cellulose (e.g., wood pulp, cotton, etc. which may be processed to extract oils, lignin, resins, etc.) or hair and/or animal fibers (e.g., fur, or wool, which may be processed to extract lanolin).

Liquid 106 used for extraction is filled into the tank 101 in FIG. 1. The liquid 106 can be water, distilled water, de-ionized water, saline, buffers, for instance phosphate-buffered saline (PBS), or other desired fluids. The diameter of the tank 101 and the liquid level within the tank 101 must be properly sized both for the required batch amount and also to ensure proper mixing. The tank 101 can have a steam jacket 102 to control the heat within the tank 101. Jacket 102 can receive steam from steam inlet 119, which passes through the jacket 102 and steam outlet 120. It should be noted that jacket 102 can alternatively be used with a coolant that would enter via inlet 119 and pass through jacket 102 before exiting at exit 120 in order to providing cooling to the contents of the tank 101. One of skill in the art would be readily able to determine if and how the features of jacket 102 should be used based on the desired temperature of the tank 101. Jacket 102 can be further surrounded by insulation shell 116 which prevent loss of heat from jacket 102 to the outside of the tank 101. Proper mixing facilitated by the selection of an appropriate tank 101 diameter and liquid 106 amount then facilitates the liquid 106 processing of the fibrous solid and the necessary heat transfer from the jacket 102 to maintain the liquid 106 and tank 101 contents at the desired temperature for processing.

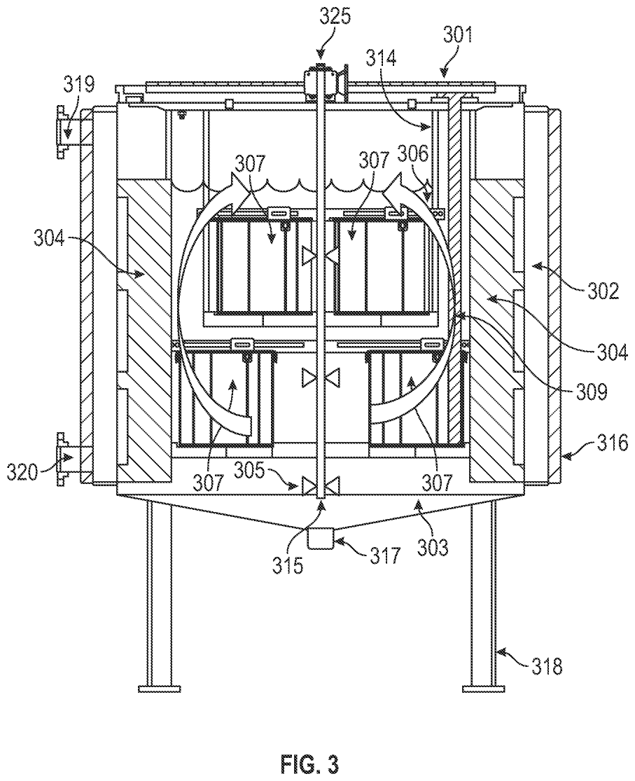

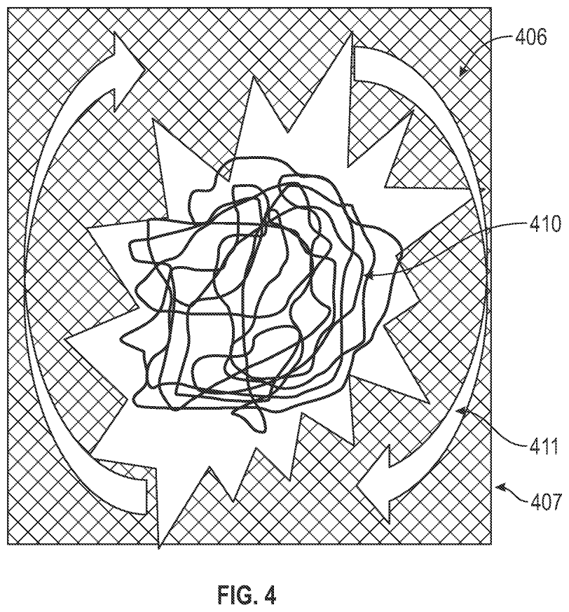

The exemplary tank 101 in FIG. 1 depicts a conical bottom 103 but other tank 101 geometries are acceptable and can be utilized. Rather than placing the fibrous solids to be processed directly into the tank 101, the fibrous solids are instead enclosed in at least one screened cage 107. Screened cages 107 segregate the fibrous solids from the interior fittings of the processing tank 101, and help ensure that the fibrous solids do not become entangled with the interior fittings. In addition to potentially damaging the tank 101 or the interior tank fittings, the fibrous solids could aggregate which would prevent proper processing of the solids, resulting in decreased yield. Screened cages 107 can be mounted on a screened cage rack/frame 114 for placement within the tank 101. Due to the placement of the screened cages 107 of the present disclosure within the tank 101, a vertically mounted agitator can be used for proper mixing without interfering with insertion or removal of the screened cages 107, but it is additionally possible to use an angular offset mixer. In the embodiment depicted in FIG. 1, a mixer shaft 115 is mounted vertically in the center of the tank 101, with impellers 105 attached thereto. While three impellers 105 are depicted, more or fewer impellers can be utilized. Mixer shaft 115 is attached to mixer gear reducer 125, which is attached to a motor (not shown) to provide the agitation. In those embodiments where a vertically mounted agitator is utilized, baffles 104 must be installed for proper mixing. Baffles 104 can be included within tank 101 in any configuration that allows the agitation to cause a liquid flow pattern that is other than a simple vortex or rotating motion of the liquid 106 around a common centerline (i.e., the mixer shaft 115). The inclusion of one or more baffles 104 break the simple vortex fluid flow, and create disruptions in the fluid flow that impact the fluid flow within the screened cages 107. The design, type, size and number of impellers 105 to be included on mixer shaft 115 are dependent on achieving the desired flow patterns, for instance as illustrated in FIGS. 3 and 4.

Tank 101 can further include typical components such as a drain 117 and support legs 118. Tank 101 and the feature thereof, including the screened cages 107, can be made of materials such as stainless steel, which will be non-reactive in a liquid environment.

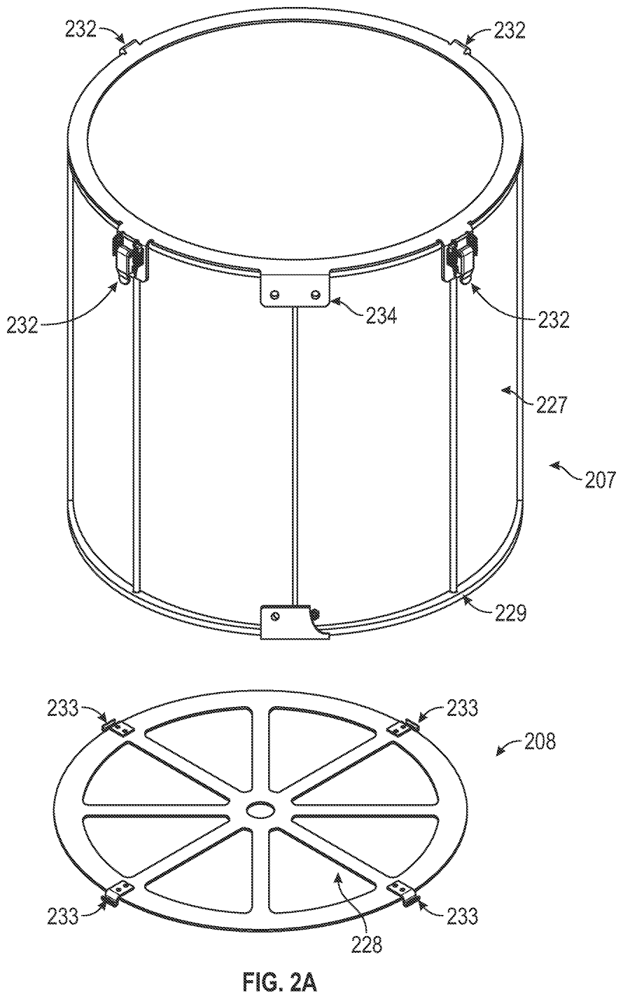

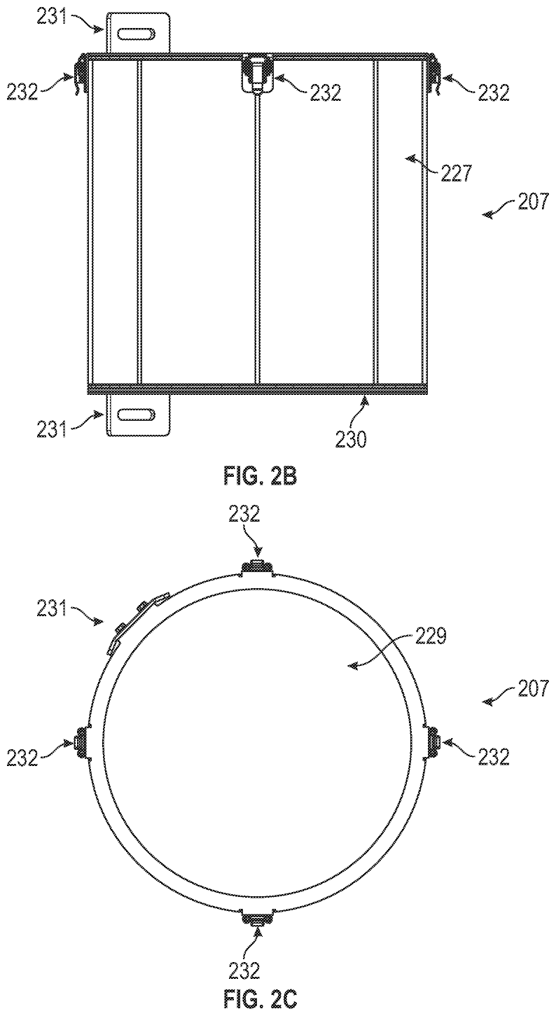

A non-limiting example of a screened cage 207 design is illustrated in FIG. 2. In one embodiment, the shape of the cage 207 should be spherical or cylindrical to minimize the locations within the screened cage 207 that interfere with the movement of the fibrous solids within the screened cages. The screened cage 207 contains the fibrous solids (not shown) while the screened lid 208 is removably affixed after the loading of the fibrous solids to the screened cage 207. Screened lid 208 can be attached to screened cage 207, for example via one or more latches 232 and corresponding catches 233, which can be alternately provided on the screened lid 208 and screened cage 207. The frame of the screened cage 207 must be strong enough to support the screen/mesh and the weight of the fibrous solids as well as to withstand the fluid forces it will be subjected to inside the tank 101. The surface area of the exterior structure should be minimized to maximize the screen/mesh area for the best flow characteristics. In one embodiment, a cylindrical screened cage 207 can include one or more of a lid 208 with lid mesh 228, side mesh 227, and a base 230 with base mesh 229 in order to maximize the screen/mesh area. Similarly, the screen/mesh opening size should be maximized for the best flow characteristics, but must be small enough to prevent the fibrous solids from escaping the screened cages 207, reaching out of the screened cages 207 to entangle on the tank 101 internal components or to prevent difficulty in removing the fibrous solids from the screened cages 207 following the liquid processing and any further ensuing processes. Screened cages 207 must be fixtured to maintain their position inside the tank 101 while having the ability to be inserted and removed safely. In one non-limiting embodiment, screened cages 207 can utilize an attachment point 234, with or without a hanger plate 231 in order to attach to the tank 101 or to a screened cage rack/frame 114.

The agitation of the liquid 306 in the tank 301 is illustrated in FIG. 3 as fluid flow representation 309. The exemplary tank 301 as illustrated includes support legs 318, conical bottom 303, drain 317, insulation shell 316, steam jacket 302 having steam inlet 319 and steam outlet 320, screened cage 307 having screened lid (not clearly shown), which can be attached to screened cage rack 314, a mixer shaft 315 having one or more mixer impellers 305 and which is attached to mixer gear reducer 325 to provide agitation to fluid 306 within the tank 301, wherein said agitation fluid flow is interrupted by one or more baffles 304.

The exemplary illustration in FIG. 3 provides an axial flow pattern, but the size, type and location of the impeller(s) 305 will vary the flow pattern within the tank 301. One critical requirement of the agitation is to provide heat transfer from the tank jacket 302 for uniform temperature throughout the vessel and the fibrous solids (not shown). As the primary objective is liquid processing of the fibrous solids, uniform mixing to and through the fibrous solid is critical. Therefore, the liquid 306 must be uniformly moved through the screened cages 307.

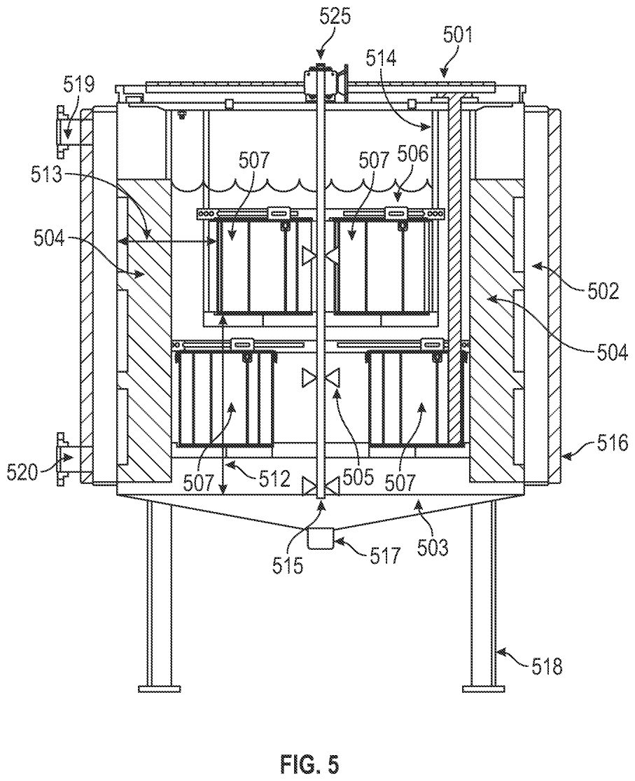

The flow pattern of the liquid 406 within the screened cages 407 is illustrated in FIG. 4 with the movement of fluid 406 and fibrous solids 410 represented as 411. If the flow path is not evenly distributed inside the screened cages 407 then the fibrous solid 410 will be compressed against one side of the screened cages 407. Once the fibrous solids 410 are compressed against one side of the screened cages 407, the fluid 406 will be constrained by the packed fibers. This will prevent good fluid flow through the packed fibers and negatively affect the heat transfer and the mass transfer of the liquid 406. This would change the desired convective heat and mass transfer to conductive heat and mass transfer. As shown in FIG. 5, the vertical distance 512 from the tank 501 bottom and the horizontal distance 513 from the tank 501 wall must be adjusted based on the flow characteristics of the fluid 506 that are affected by the tank 501 geometry and the type, number, size(s) and location(s) of impeller(s) 505. Once the ideal flow pattern (not shown in FIG. 5, see 411 in FIG. 4) is established inside the screened cages 507 then liquid extraction, heat transfer and other operations in the tank will be optimized. The screened cages 507 also have the benefit of safe entry and extraction from the tank.

FIG. 5 illustrates the dimensions that can be used for locating the screened cages to optimize heat and mass transfer, while allowing for the fluid agitation within the tank 501 to provide the desired flow pattern within the screened cages 507. For completeness, tank 501 in FIG. 5 is illustrated having all of the components previously described herein, including support leg 518, conical bottom 503, drain 517, insulation shell 516, steam jacket 502 having steam inlet 519 and steam outlet 520, screened cage 507 having screened lid (not shown), which can be attached to screened cage rack 514, a mixer shaft 515 having one or more mixer impellers 505 and which is attached to mixer gear reducer 525 to provide agitation to fluid 506 within the tank 501, wherein said agitation fluid flow is interrupted by one or more baffles 504.

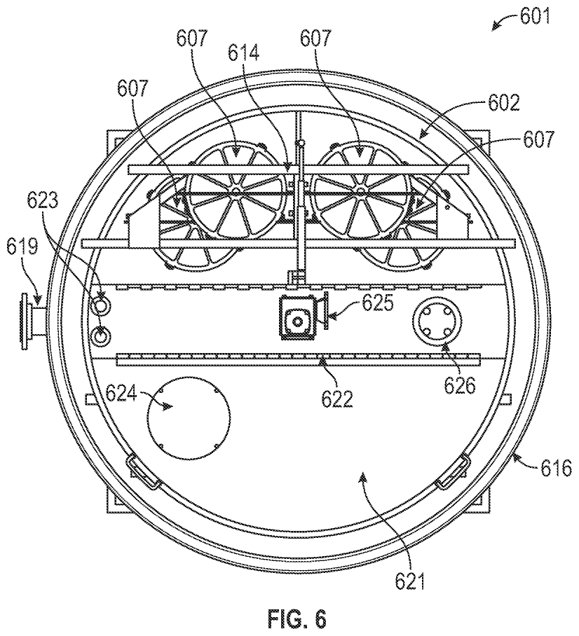

FIG. 6 provides a top view of a processing tank 601 according to the present invention, including the lid 621, the components incorporated into the lid 621, as well as those within the tank 601 that can be seen through the lid 621. The steam jacket 602, steam inlet 619, and insulation shell 616 are visible on the exterior edge of the tank 601, and screened cages 607 are shown within the tank 601 as attached to screened cage rack/frame 614, showing an exemplary arrangement of two layers of screened cages 607 with the top layer offset horizontally from the lower layer. Tank 601 additionally comprises hot and cold water inlets 623, and lid 621 includes lid hinge 622. Additional components of lid 621 include vent cover 624, and level transmitter 626. Mixer gear reducer 625 is also present, providing a visual marker for the screened cages 607 in relation to the vertical agitation system comprising a mixer shaft and one or more impellers.

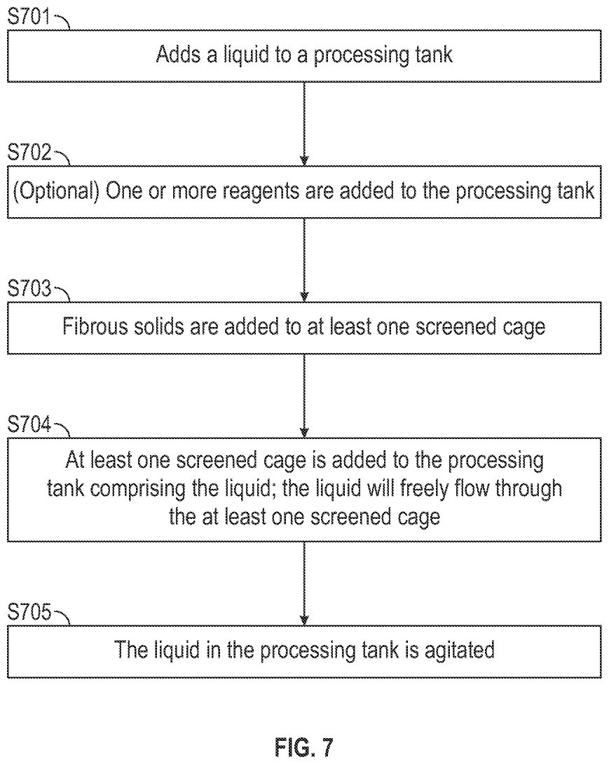

FIG. 7 provides a flow chart for an exemplary method of processing fibrous solids in liquid according to the present invention. While FIG. 7 provides multiple steps shown in sequence, in practice the steps may be combined, or their order may be changed based on the fibrous solids to be processed and the processing to occur. Furthermore, the physical elements described with respect to FIG. 7 can include any of the specific physical elements described in any of FIGS. 1-6, including the various alternate embodiments. In one non-limiting, exemplary embodiment, the fibrous solids can be silk cocoons, for example, those of the Bombyx mori silk moth or the Bombyx mandarina wild silk moth. Other examples of fibrous solids include, without limitation, cellulose (e.g., wood pulp, cotton, etc. which may be processed to extract oils, lignin, resins, etc.) or hair and/or animal fibers (e.g., fur or wool, which may be processed to extract lanolin).

Step 701 of FIG. 7 comprises adding a liquid to a processing tank. Such liquid can be water, saline, buffer (such as PBS) or other relevant liquid. In some embodiments, the presence of such liquid will act as a solvent. For example, in the instance of a fibrous solid which are Bombyx mori cocoons, water will act as a solvent allowing the dissolution of the cocoons into its components of fibroin and sericin. In Step 702, one or more additional reagents are optionally added to the processing tank. It will be readily determined by one of skill in the art whether such additional reagents are needed, and if so, what the one or more reagents will comprise, based on the reaction to be performed in the processing step. For instance, additional reagents can be a solvent, a salt, pH regulators, or others known to those of skill in the art. For example, in the instance of a fibrous solid which are Bombyx mori cocoons, the one or more reagents can be a salt. For instance, the salt can optionally be sodium carbonate, which will aid in dissolving sericin.

In step 703, fibrous solids are added to at least one screened cage. In Step 704, the at least one screened cage is added to the processing tank comprising the liquid, such that the liquid will freely flow through the at least one screened cage. In Step 705, the liquid in the processing tank is agitated, for instance by means of an impeller, such that the liquid uniformly flows through the at least one screened cage. Such agitation causes the fibrous solids to rotate freely within the at least one screened cage. In addition to steps 701-705, other optional steps may be performed, such as heating the tank, for instance, via a steam jacket, adding one or more additional reagents, incubating the fibrous solids at a desired temperature for a desired amount of time, and rinsing the fibrous solids.

In some embodiments, the performance of the process shown in FIG. 7 will result in the dissolving of the fibrous solids, such that one or more components of the fibrous solids are released. In certain embodiments, one or more of the components will be of a size to be retained within the screened cages. In further embodiments, one or more of the components will be able to pass through the screened cages, e.g., a substance that is in solution. In those instances where the one or more components are retained in the one or more screened cages, the retained components can be subjected to an agitation flow path that prevents packing of the one or more retained components within the screened cage.

During Step 703, the at least one screened cage is provided and receives fibrous solids. Depending on the fibrous solids to be used, one of skill in the art will be able to readily determine the appropriate size openings for the mesh that is on at least one surface of the screened cage. In selecting the appropriate size, the properties of the fibrous solids will be considered (i.e., length, width, etc.) as well as that of any components of the fibrous solids that are desired to be either contained by the screened cage or which are desired to be able to pass through the screened cage. By choosing an appropriately sized mesh opening, a fluid agitation flow will be able to be generated within the at least one screened cage, and the mesh openings will be sized to contain the retained components while preventing the fibrous materials from clogging or wrapping around the mesh.

During Step 704, the at least one screened cage is added to the processing tank in a manual or automatic manner which positions the screened cage to a desired position. Such positioning should be done in a repeatable manner, such that the at least one screened cages can be repeatedly removed from and added to the processing tank into one of a number of specifically defined positions. For instance, one example of such positioning can be seen in FIGS. 3 and 6, wherein two vertical layers of screened cages are provided, with the upper layer screened cages being offset horizontally from the center point of each of the lower layer of screened cages. Further, during Step 704, adding the at least one screened cage to the processing tank in a desired position additionally comprises securing the at least one screened cage such that rotation and/or deflection of the at least one screened cage from the desired position is prevented. Such securing can occur by any means known to those of skill in the art, such as, securing the one or more screened cages on a mechanism such as an external support structure which is then lowered into the processing tank and secured to the tank, assemblies located in the tank to which the screened cages can be removably secured via a hook, handle, screw, bolt, slidable fastener or other means known to those of skill in the art. Similarly, the one or more screened cages can be removably fastened to each other, prior to being inserted into the tank, with the assembly of screened cages being removably secured within the tank as a whole.

In one aspect, the method additional comprises that the step of removing the one or more screened cages from the tank results in the draining of liquid from the one or more screened cages. In such an embodiment, the at least one screened cage can act as a sieve or strainer, allowing the liquid in the tank to drain from the at least one screened cage as it is lifted from the tank, while any retained components remain within the screened cage. In addition, once removed from the tank, the screened cages can act as a vessel for the retained components and/or fibrous materials to be further subjected to additional processing steps. For instance, the screened cages can be subjected to centrifugal force in order to remove additional liquid and/or reagents from the retained components and/or remaining fibrous materials.

The method described in FIG. 7 can additionally comprises additional steps to further process the retained components and/or fibrous materials. For example in one embodiment, the method described in FIG. 7 additionally comprises the steps of removing the one or more screened cages from the tank, inserting the one or more screened cages into an oven; and drying the retained components and/or fibrous materials. In another subsequent or alternate embodiment, the method can additional comprise the additional step of performing further processing on the retained material within the at least one screened cage, for instance one or more of dissolving the retained material or subjecting the retained material to a chemical reaction.

### Example

### Degumming of Cocoons Using Screened Cages

Collapsed cocoons were obtained. Three screened cages were each loaded with 50 g of the collapsed cocoons. The degumming phase of extracting fibroin from the cocoons was performed, with a 60 minute boiling time. The boiling solution (water and salt) was kept at 95-100° C. A single impeller was started approximately 2-3 minutes after the degumming phase started, and was maintained at an agitation speed of 900-1200 rotations per minute for the remainder of the degumming phase. The solution did not appear foamy during the degumming phase. Results are shown below in Table 1:

TABLE 1

| | | | Residual | | | | |
|---|---|---|---|---|---|---|---|
| | | | salt | Solid | Optical | | |
| | Mw | | amount | concentration | clarity | | Viscosity |
| Conditions | (kDa) | PDI | (ppm) | (%) | (abs) | pH | (cP) |
| 150 g | 168.5 | 2.1 | 23.7 | 5.52 | 0.0865 | 6.42 | Between |
| Cocoons in | | | | | | | 12-18 |
| 3 Screened | | | | | | | |
| Cages - 60 | | | | | | | |
| min. boil | | | | | | | |

As can be seen from the results in Table 1, the retained contents of the screened cages had a molecular weight following the processing phase of 168.5 kDa, demonstrating that the fibroin was successfully released from the cocoons. This correlates to the screened cages providing good heat transfer to the fibrous solid (cocoon) contents. Further, sericin was completely removed from the retained contents, demonstrating that the mass transfer allowed by the screened cages was also good.

### Definitions

In referring to the description, specific details are set forth in order to provide a thorough understanding of the examples disclosed. In other instances, well-known methods, procedures, components and circuits have not been described in detail as not to unnecessarily lengthen the present disclosure.

It should be understood that if an element or part is referred herein as being “on”, “against”, “connected to”, or “coupled to” another element or part, then it can be directly on, against, connected or coupled to the other element or part, or intervening elements or parts may be present. In contrast, if an element is referred to as being “directly on”, “directly connected to”, or “directly coupled to” another element or part, then there are no intervening elements or parts present. When used, term “and/or”, includes any and all combinations of one or more of the associated listed items, if so provided.

Spatially relative terms, such as “under” “beneath”, “below”, “lower”, “above”, “upper”, “proximal”, “distal”, and the like, may be used herein for ease of description to describe one element or feature's relationship to another element(s) or feature(s) as illustrated in the various figures. It should be understood, however, that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, a relative spatial term such as “below” can encompass both an orientation of above and below. The device may be otherwise oriented (rotated 90 degrees or at other orientations) and the spatially relative descriptors used herein are to be interpreted accordingly. Similarly, the relative spatial terms “proximal” and “distal” may also be interchangeable, where applicable.

The term “about,” as used herein means, for example, within 10%, within 5%, or less. In some embodiments, the term “about” may mean within measurement error.

The terms first, second, third, etc. may be used herein to describe various elements, components, regions, parts and/or sections. It should be understood that these elements, components, regions, parts and/or sections should not be limited by these terms. These terms have been used only to distinguish one element, component, region, part, or section from another region, part, or section. Thus, a first element, component, region, part, or section discussed below could be termed a second element, component, region, part, or section without departing from the teachings herein.

The terminology used herein is for the purpose of describing particular embodiments only and is not intended to be limiting. The use of the terms “a” and “an” and “the” and similar referents in the context of describing the disclosure (especially in the context of the following claims) are to be construed to cover both the singular and the plural, unless otherwise indicated herein or clearly contradicted by context. The terms “comprising,” “having,” “includes”, “including,” and “containing” are to be construed as open-ended terms (i.e., meaning “including, but not limited to,”) unless otherwise noted. Specifically, these terms, when used in the present specification, specify the presence of stated features, integers, steps, operations, elements, and/or components, but do not preclude the presence or addition of one or more other features, integers, steps, operations, elements, components, and/or groups thereof not explicitly stated. Recitation of ranges of values herein are merely intended to serve as a shorthand method of referring individually to each separate value falling within the range, unless otherwise indicated herein, and each separate value is incorporated into the specification as if it were individually recited herein. For example, if the range 10-15 is disclosed, then 11, 12, 13, and 14 are also disclosed. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

It will be appreciated that the methods and compositions of the instant disclosure can be incorporated in the form of a variety of embodiments, only a few of which are disclosed herein. Variations of those embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. A method of processing fibrous solids in liquid comprising the steps of:
adding liquid to a processing tank;
optionally adding one or more reagents to the processing tank;
providing at least one screened cage containing fibrous solids;
adding the at least one screened cage to the processing tank, wherein the liquid freely flows through the at least one screened cage;
agitating the liquid in the processing tank such that the liquid uniformly flows through the at least one screened cage; wherein the fibrous solids rotate freely within the at least one screened cage.

2. The method of claim 1, wherein the fibrous solids are dissolved to release one or more components of the fibrous solids.

3. The method of claim 2, wherein the one or more components are retained within the screened cage.

4. The method of claim 3, wherein the one or more retained components are subjected to an agitation flow path that prevents packing of the one or more retained components within the screened cage.

5. The method of claim 1, wherein the at least one screened cage comprises mesh having an opening sufficient to allow for fluid agitation flow within the at least one screened cage, wherein the opening is sized to contain the retained components, and prevent the fibrous materials from clogging or wrapping around the mesh.

6. The method of claim 1, wherein adding the at least one screened cage to the processing tank manually or automatically positions the screened cage to a desired position in a repeatable manner.

7. The method of claim 6, wherein adding the at least one screened cage to the processing tank in a desired position additionally comprises securing the at least one screened cage such that rotation and/or deflection of the at least one screened cage from the desired position is prevented.

8. The method of claim 1 wherein the one or more reagents comprises a solvent or a salt.

9. The method of claim 1, additionally comprising the steps of:
removing the one or more screened cages from the tank;
inserting the one or more screened cages into an oven; and
drying the retained retained components and/or fibrous materials.

10. The method of claim 9, wherein the step of removing the one or more screened cages from the tank results in the draining of liquid from the one or more screened cages.

11. The method of claim 9, comprising the additional step of subjecting the at least one screened cage to centrifugal force to remove one or more reagents from the retained components.

12. The method of claim 9, comprising the additional step of performing additional processing on the retained material with the at least one screened cage.

13. The method of claim 12, wherein the additional processing comprises one or more of dissolving or a chemical reaction.

14. The method of claim 1, wherein the fibrous solids are selected from the group consisting of silk cocoons, cellulose, and animal fibers.

15. The method of claim 1, wherein the salt is sodium carbonate.

16. The method of claim 3, wherein the retained component is fibroin.

17. A device for processing fibrous solids in liquid comprising at least one screened cage having a lid.

18. The device of claim 17, wherein the lid is removably attached.

19. The device of claim 17, wherein the lid is removably attached by one or more latches.

20. The device of claim 17 comprising an external support structure and one or more mesh walls located interior to the external support structure.

21. The device of claim 20, wherein the external support structure and one or more interior mesh walls allow for a fluid flow pattern within the screened cage.

22. The device of claim 17, wherein the device is configured to function as a sieve to remove liquid from a material placed inside the device.

23. The device of claim 17, wherein the fibrous solids are selected from the group consisting of silk cocoons, cellulose, and animal fibers.
